(19) United States
(12) Patent Application Publication
(10) Pub. No.: US 2017/0058127 A1
(43) Pub. Date: Mar. 2, 2017

(54) PRODUCTION OF NANOCELLULOSE AND CARBON BLACK FROM LIGNOCELLULOSIC BIOMASS

(71) Applicant: Georgia Southern University Research and Service Foundation, Statesboro, GA (US)

(72) Inventor: Linoj Kumar Naduvile Veettil, Pooler, GA (US)

(21) Appl. No.: 15/245,916

(22) Filed: Aug. 24, 2016

Related U.S. Application Data
(60) Provisional application No. 62/209,071, filed on Aug. 24, 2015.

(51) Int. Cl. C09C 1/48; D21C 1/06; D21C 1/04

(52) U.S. Cl. CPC C09C 1/48; D21C 1/04; D21C 1/06; C01P 2006/12

(57) ABSTRACT

Disclosed herein are integrated processes for preparing useful materials from renewable biomass feedstocks. The materials include nanocellulose and bio-based carbon black. The processes are characterized by low energy input requirements. The nanocellulose and bio-based carbon black produced according to the disclosed processes have improved properties relative to nanocellulose and bio-based carbon black produced by more energy intensive processes.

### CROSS-REFERENCE TO RELATED APPLICATION

This application claims the benefit of U.S. Provisional Application 62/209,071, filed Aug. 24, 2015, the contents of which are hereby incorporated in its entirety.

### FIELD OF THE INVENTION

The present invention is directed to a process for transforming biomass, and useful compositions obtained therefrom. In accordance with certain embodiments, the invention is directed to the conversion of biomass into nanocellulose. In accordance with certain embodiments, the invention is directed to the conversion of biomass into carbon black.

### BACKGROUND

Nanocellulose is recognized to be an ideal next generation material in a variety of applications ranging from packaging to light weight automotive composites. Nanocellulose has a strength to weight ratio eight times higher than steel and stiffness higher than glass fibers. Despite the high prospects of nanocellulose, the material has not been adopted commercially because current manufacturing technologies are energy inefficient and chemically intensive. To obtain nanocellulose, biomass must undergo a 6-9 order of magnitude reduction in both length and diameter as well as separation from other biomass components. Since biomass is flexible and tenacious, conventional size reduction is highly energy intensive. Many of the mechanical processes currently used require intense refining and homogenization to separate micro- and nanofibrillated cellulose even from chemically bleached pulps. In some cases, mechanical comminution of untreated fibers into nanomaterial requires up to 100 MWh per ton (see Moser at al. BIORESOURCES (2015). 10(2):2360-2375).

Many processes for the production of nanocellulose use expensive chemically bleached pulp ($800/ton) and microcrystalline cellulose ($2000/ton) as the starting feedstock. The high price of these materials combined with low product yields, make them impractical as commercial feedstocks. For example, assuming a 50% nanocellulose product yield, feedstock costs under current production schemes are $1.6-4.0/kg. In addition to high energy and raw material costs, many of the current manufacturing technologies for nanocellulose are also highly chemically intensive. For example, large volumes of sulfuric acid are used to hydrolyze bleached chemical pulp as current production methods lack adequate acid recovery schemes. In some cases, up to ten kilograms of sulfuric acid is necessary to produce a single kilogram of cellulose nanocrystals. The chemical requirements are even higher when the chemical requirements for the production of the starting feedstocks considered. Other proposed production methods require large volumes of organic solvents and use of expensive catalysts. For example, use of organic agents such as 2,2,6,6-tetramethylpiperidine 1-oxyl radical

(TEMPO) to liberate nanofibrils from cellulosic pulp (see Saito at al. BIOMACROMOLECULES (2006). 7(6):1687-1691). The TEMPO reagent is expensive and its use for the large-scale production of nanocellulose is not commercially practical. Recovery and recycling issues further complicate the use of TEMPO. Researchers have also used ionic liquids such as ZnCl₂ in high dosages: 20 kilograms of ionic liquid for every kilogram of nanocellulose in the best case scenarios, which is again not commercially viable as efficient methods for the recovery of the ionic liquids are as yet unknown. Furthermore, it is often necessary to include mechanical refining and homogenization processes along with these chemical treatments. Despite the high costs of these prior art manufacturing methods, these methods result in an extremely low yield of nanocellulosic materials. Current yield of nanocellulose is around 50% based on chemically bleached pulp, resulting in an overall yield of only 15% based on the starting material.

Some production methods have used enzymatic pre-treatment to reduce the energy required in the subsequent refining steps used to product nanocellulose. However, these endo-glucanase rich enzymes are expensive and large amounts of them are necessary. Further, enzyme treatments are often combined with a chemical treatment and high shear homogenization; such processes cannot be used produce cellulose nanocrystals.

Carbon black is a paracrystalline allotrope of carbon and related to activated carbon, the latter having a higher surface area to volume ratio. Carbon black is traditionally obtained by incomplete combustion of heavy petroleum products, e.g., tars. Carbon black is primarily used as a filler in tires and other rubber and polymeric products, and as a pigment in various inks, plastics, and paints. The petroleum-based carbon black industry is under increasing pressure from governments and environmental groups, as conventional manufacturing for carbon black result in significant greenhouse gas emissions, and the production of Class 2B carcinogens. Specifically, petroleum-based carbon black is generally high in polyaromatic hydrocarbon (“PAH”) content. Bio-based carbon black, also referred to as charcoal or “biochar,” can be produced by a number of conventional methods including the pyrolysis or gasification of biomass. Biomass used in the production of charcoal include both forest-based and agricultural feedstocks, such as wood, bagasse and corn stover. Feedstocks may also include product streams derived in biomass processing, as in the production of carbonaceous powder from lignin via pyrolysis, where the starting feedstock was poplar hydrolysate solid residues from a bioethanol process (see Snowdon et al. ACS SUSTAINABLE CHEM. ENG. (2014) 2:1257-1263). Torrefaction of biomass is known, with the studies conducted in France as early as the 1930's to produce synthesis gas. A number of different torrefaction designs have been proposed, for instance in U.S. Pat. No. 8,449,742 including references cited therein. Alternatives to conventional torrefaction methods, such as the use of microwave energy to replace conductive and convective heating have also been explored, for instance, in US Published Application No. 2011/0219679. Recently, torrefaction of biomass has been considered as a means of producing a coal replacement. Additionally, it has been proposed to use torrefaction as a means of valorizing residues generated during the conversion of biomass to biofuels such as ethanol. Torrefaction has also been cited as a pretreatment step prior to pyrolysis to produce char and pyrolysis oil.

It is an object of the invention to provide an integrated process for the conversion of biomass into commercially relevant products, such as nanocellulose and carbon black.

It is another object of the invention to provide a process for transforming biomass which requires considerably less energy inputs than currently available processes.

It is a further object of the invention to provide nanocellulose and bio-based carbon black having improved properties over nanocellulose and carbon black produced according to conventional methods.

### SUMMARY

In accordance with the purposes of the disclosed methods, as embodied and broadly described herein, the disclosed subject matter relates to compositions and methods of making and using the compositions. More specifically, according to the aspects illustrated herein, there are provided methods of processing biomass and products obtained therefrom. The processes can be carried out with reduced energy inputs in comparison with conventional methods of processing biomass.

According to further aspects illustrated herein, bio-based carbon black is provided. In another aspect, nanocellulose is provided. In addition to these two high value biomaterials, volatile chemicals released during the process from the extractive and hemicellulosic components of biomass can be condensed in an appropriate medium and recovered as valuable by-products. These by-products include, but are not limited to sterols, tall oil, rosin, acetic acid, furan derivatives and other specialty chemicals.

According to the present invention, extractive and hemicellulosic components volatilized during torrefaction can also be recovered as secondary by-products, which includes, but are not limited to sterols, tall oil, rosin, acetic acid, furan derivatives and other specialty chemicals and nutraceuticals. These volatile fractions can be sequentially recovered via time gradient condensation in suitable solvents, which can be either be polar or non-polar solvents or their combination depending on the target compounds to be recovered. As a result, the process of traditional destructive distillation is thereby enhanced allowing for the recovery of these components as high-value bio-based chemicals. Subsequent fractionation of the desired compounds can include, but is not limited to, solvent extraction, fractional distillation, membrane separation, selective freezing, freeze-drying, and acid-base extractions.

The disclosed process employs torrefaction as a front end processing step to reduce the energy consumption for the production of nanocellulose and carbon black. When the torrefaction step is included, a 75-100% increase in the yield of nanocellulose can be obtained. The nanocellulose also exhibits greater stability and uniformity due to the flexibility of the disclosed process. Furthermore, because the disclosed processes can be used to produce carbon black from biomass and lowers the energy and chemical intensity of nanocellulose production, they represent “green” alternatives to current manufacturing processes.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 depicts a schematic representation of an embodiment of the processes disclosed herein, the delignification pathway.

FIG. 2 depicts a nanocellulose sample produced according to an embodiment of the processes disclosed herein, the hydrolysis pathway.

FIG. 3 depicts a nanocellulose sample produced according to an embodiment of the processes disclosed herein.

FIG. 4 depicts transparent gels produced from a nanocellulose sample produced according to an embodiment of the processes disclosed herein.

FIG. 5 depicts a stabilized aqueous foam produced from a nanocellulose sample produced according to an embodiment of the processes disclosed herein.

FIG. 6 depicts a lignaceous carbon sample produced according to an embodiment of the processes disclosed herein.

FIG. 7 depicts a scanning transmission electron microscopic (STEM) image of cellulose nanofibrils produced according to an embodiment of the processes disclosed herein.

FIG. 8 depicts the thermogravimetric analysis of both pure nanocrystalline cellulose (top trace) and cellulose nanofibrils (second from bottom trace), and cellulose nanofibrils with a residual lignin content of 2% (bottom trace) produced according to an embodiment of the processes disclosed herein compared to a commercial sample of nanocrystalline cellulose (dashed trace).

FIG. 9 depicts a STEM image of lignin particles produced according to an embodiment of the processes disclosed herein.

FIG. 10 depicts a STEM image of cellulose nanocrystals produced according to an embodiment of the processes disclosed herein.

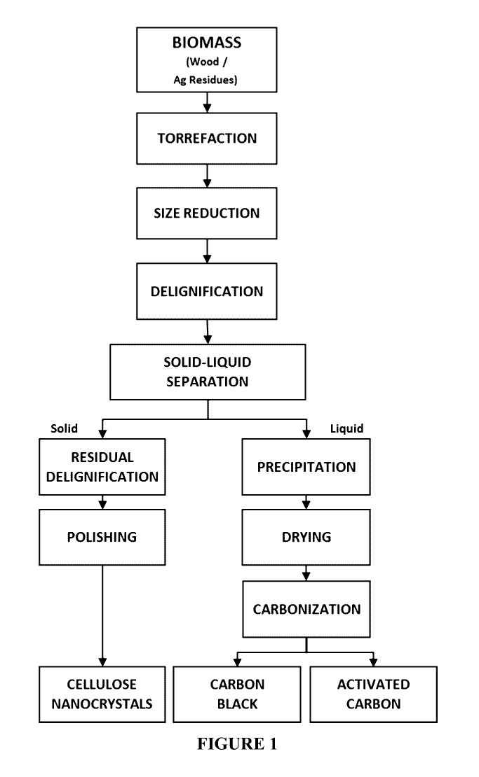

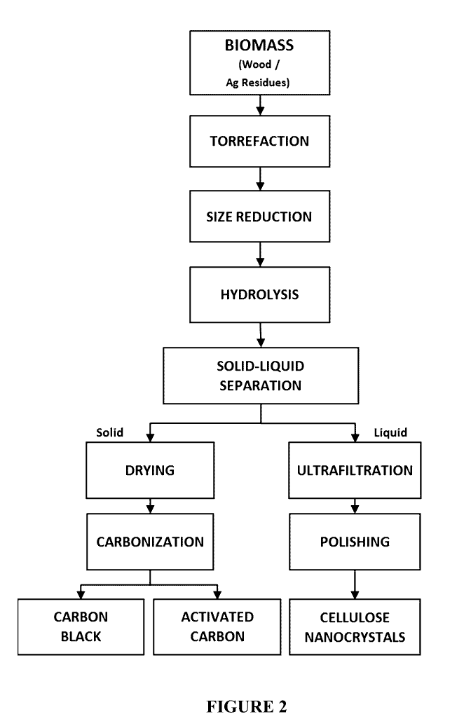

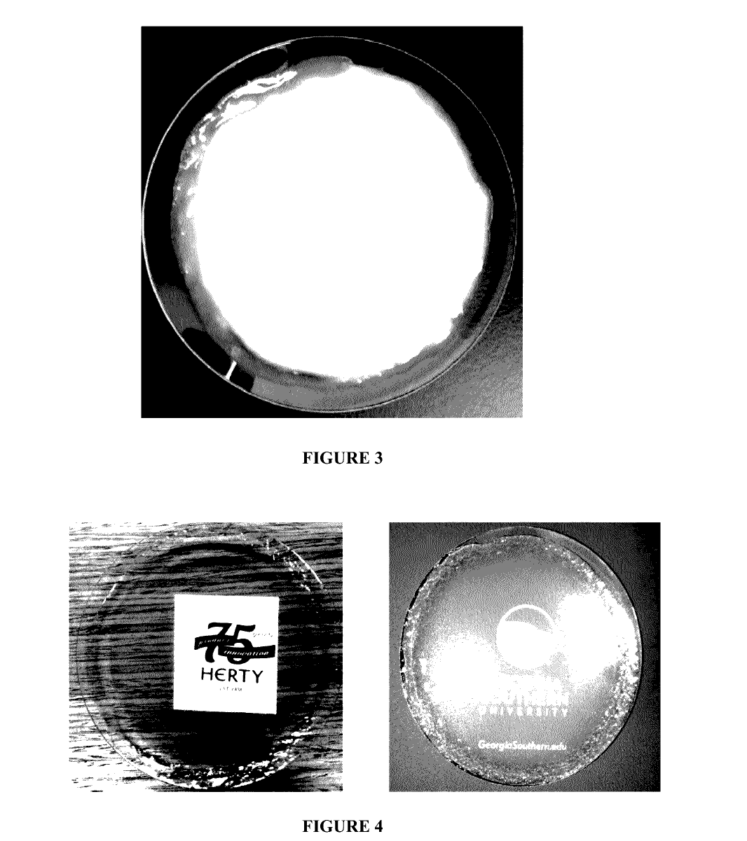

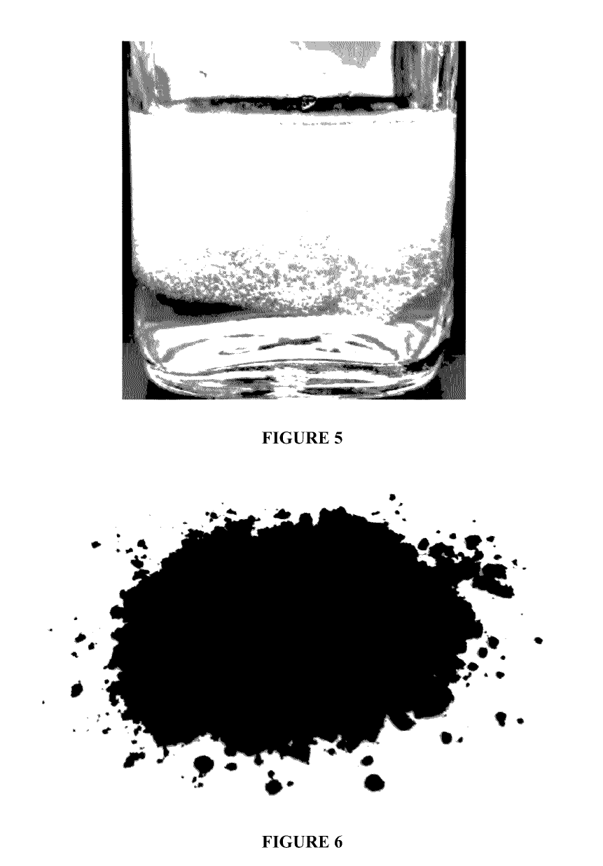

### DETAILED DESCRIPTION

The methods and compositions described herein may be understood more readily by reference to the following detailed description of specific aspects of the disclosed subject matter and the Examples included therein.

Before the present methods and compositions are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings: Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

By substantially the same is meant the values are within 5% of one another, e.g., within 3%, 2% or 1% of one another.

As used herein, “nanocellulose” refers collectively to cellulose nanofibrils and cellulose nanocrystals.

As used herein, “cellulose nanofibrils” refers to elementary units of cellulose having a length of 400 nm or more and a diameter less than 100 nm, preferably less than 50 nm.

As used herein, cellulose nanocrystals have a length between 100-400 nm and a diameter less than 20 nm.

As used herein, bio-based carbon black refers to an allotrope of carbon having a high surface area, and further characterized by the absence of polyaromatic hydrocarbons.

In certain embodiments, nanocellulose and bio-based carbon black can be obtained by torrefying biomass, which may or may not be accompanied by a size reduction step. The torrefied biomass can be subjected to bulk delignification which separates nanocellulose from lignin via a step-wise process. Bulk delignification causes precipitation of nanocellulose from a solution of lignin. The precipitated nanocellulose can be recovered by filtration and purified. The lignin solution can be dried and subsequently carbonized to give bio-based carbon black.

In other embodiments, nanocellulose and bio-based carbon black can be obtained by torrefying biomass, which may or may not be accompanied by a size reduction step. The torrefied biomass can be subjected to acidic hydrolysis. Acidic hydrolysis causes precipitation of lignin from a solution of nanocellulose. The precipitated lignin can be recovered by filtration, and then carbonized in a manner similar to that in the bulk delignification process.

The nanocellulose solution can be dried and subsequently purified.

### Torrefaction

The torrefaction process depolymerizes, dehydroxylates and partially carbonizes lignin present in the biomass. Torrefaction makes biomass extremely brittle and inelastic thus enabling the macro- to nano-level transformation of biomass with minimum energy consumption while also allowing an easy and clean separation of nanocellulose in the downstream processing. While the torrefaction process may lead to size reduction, due to mechanical action, the overall impact on particle size is limited.

The torrefaction can be carried out in a defined gaseous environment, including steam, air, O₂ or N₂. Gaseous environments which contain oxygen are herein designated oxidative environment, and gaseous environments which do not contain appreciable amounts of oxygen are herein designated non-oxidative environments. Hydrothermal carbonization (HTC) describes a torrefaction process that is conducted at pressures above near atmospheric conditions and at high liquid to solid ratios (see Funke and Ziegler. BIOFUELS, BIOPRODUCTS AND BIOREFINING. (2010) 4(2): 160-177).

(2010) 4(2): 160-177). Non-oxidative environments are preferred to maximize the yield of torrefied biomass and to prevent the possibility of ignition and explosion of the biomass during the torrefaction process, although we are not bound by this limitation. Torrefication can be carried out at a temperature from between 100-500° C., 150-350° C., 175-300° C., or 200-275° C. The torrefaction can be carried out at pressures between 0.1-5.0 MPa. Torrefication can be carried out for a period of time not longer than two hours, not longer than 1.5 hours, not longer than 1 hour, not longer than 45 minutes, or not longer than 30 minutes. In some embodiments, torrefication can be carried out for a period of time from 2 minutes to 2 hours, from 5 minutes to 1 hour, from 5 minutes to 45 minutes, or from 5 minutes to 30 minutes. The torrefied biomass can be cooled by purging an inert gas into the reactor or circulating a coolant outside of the torrefaction reactor.

Torrefication can be carried out in the presence of one or more catalysts. Suitable catalysts include acid catalysts such as monoprotic or polyprotic mineral or organic acids, and alkaline catalysts such as ammonium hydroxide and the hydroxides of alkali and alkali earth metals. The biomass can be chemically pretreated prior to torrefaction. Exemplary chemical treatments include aqueous acid, aqueous base and oxidative treatments. Torrefication can be carried out both with a chemical pretreatment, and in the presence of catalyst.

Suitable biomass starting materials include, but are not limited to, woods, grasses, agricultural residues, and products, by-products and otherwise waste streams of biomass processing, such as distillers grains producing during fuel ethanol production, lignin generated during pulping processes, bagasse generated during the processing of sugar cane, wood slabs and sawdust generated during lumber production, and as well as recovered wood, paper and paperboard and wood-based construction waste.

### Size Reduction

After torrefaction, the torrefied biomass can be subjected to a size reduction step. Methods for size reduction are well known and include the use of hammer mills, ball mills, grinder, refiners and other mechanical devices. Size reduction of the torrefied biomass is practiced to produce particles less than 100 μm, 90 μm, 80 μm, 70 μm, 60 μm, 50 μm, 40 μm, 30 μm, 20 μm, 15 μm, 10 μm, 5 μm, 4 μm, 3 μm, 2 μm, 1 μm or 0.5 μm. In some embodiments, the biomass can be subjected to a size reduction step via grinding to produce particles having an average particle size distribution between 0.5-50 μm, 0.5-25 μm, 0.5-10 μm, 1-10 μm or 1-5 μm as measured by sieve analysis, dynamic light scattering or other methods used for this purpose.

Size reduction of conventional biomass is an energy intensive procedure, often requiring greater than 2,000 kWh/ton. On the other hand, biomass torrefied as described above can require less than 2,000 kWh/ton, 1,000 kWh/ton, 500 kWh/ton, 250 kWh/ton, 100 kWh/ton, 75 kWh/ton, 50 kWh/ton, 25 kWh/ton, or 10 kWh/ton, to achieve the same size reduction. Generally, no mass loss is observed during the size reduction step.

Unless specified otherwise, the term “torrefied biomass” includes torrefied biomass that has undergone a size reduction, and torrefied biomass which has not undergone a size reduction.

Torrefaction as described above can produce torrefied biomass in a yield of at least 50%, 60%, 70%, 75%, 80%, 85%, or 90% relative to the dry weight of the starting biomass. Torrefaction as described above can produce torrefied biomass in a yield ranging from 50-95%, 60-95%, 70-90%, 75-90%, or 75-85% relative to the starting biomass.

### Delignification Pathway

According to the present invention, alkali delignification can include a bulk delignification stage and a residual delignification stage. Bulk delignification can be accomplished by lignin depolymerization, followed by removal of the bulk of the lignin present in the material. Bulk delignification can remove at least 25%, 30%, 35% 40%, 45%, 50%, 55%, 60%, 65% 70%, 75%, 80%, 85%, 90% or 95% of the lignin present in the torrefied material. Bulk delignification can remove from between 25-95%, 30-95%, 35-95%, 40-95%, 45-95%, 50-95%, 50-90%, 55-90%, 60-90%, 60-85%, 65-85%, 70-85% or 70-80% of the lignin present in the torrefied material.

The bulk delignification stage can also reduce the chain length of the cellulose. Typically after torrefaction and grinding, the cellulose present has a chain length of a few micrometers. After bulk delignification, the cellulose can have a chain length that is less than 1 μm, 0.9 μm, 0.8 μm, 0.7 μm, 0.6 μm, 0.5 μm, 0.4 μm, 0.3 μm, 0.2 μm, or 0.1 μm. After bulk delignification, the cellulose can have a chain length that is between 0.1-1 μm, 0.1-0.9 μm, 0.2-0.9 μm, 0.3-0.9 μm, 0.1-0.8 μm, 0.2-0.8 μm or 0.3-0.8 μm.

Bulk delignification may be carried out by combining torrefied biomass with an aqueous solution of a base, preferably a strong base. Exemplary strong bases include hydroxides like sodium hydroxide and potassium hydroxide. Combining torrefied biomass with an aqueous base produces a suspension. The solids component of the suspension can be at least 1%, 2%, 3%, 4%, 5%, 6%, 7%, 8%, 9%, 10%, 15%, 20%, 25%, 30%, 35%, 40%, 45%, 50%, 55%, 60%, 65%, 70% or 75% of the total suspension. The solids component of the suspension can be from 1-75%, 1-70%, 1-60%, 1-50%, 2-50%, 3-50%, 4-50%, 5-50%, 5-40%, 5-35%, 5-30%, 10-30%, 15-30%, or 15-25% of the total suspension. Ratio of alkali to biomass is 1-100%. The suspension can heated to a temperature between 23-200° C., 50-200° C., 100-200° C., 125-200° C., 125-175° C., 150-175° C., or 125-150° C. The suspension can be held at this temperature for a period of at least 5 minutes, 10 minutes, 15 minutes, 20 minutes, 25 minutes, 30 minutes, 35 minutes, 40 minutes, 45 minutes, 50 minutes, 55 minutes, 60 minutes, 70 minutes, 80 minutes, 90 minutes, 100 minutes, 110 minutes, or 120 minutes. After such time, the suspension can be filtered to produce a liquid containing dissolved lignin and a cellulose-rich insoluble fraction.

In some embodiments, the torrefied biomass can be treated with an oxidant prior to exposure to the aqueous base. Suitable oxidants include peroxyacids, such as peroxyacetic acid and peroxymonosulfuric acid (Caro's acid), hydrogen peroxide, and sodium hypochlorite.

The cellulose fraction can be chemically converted to nanocellulose through a residual delignification stage. The residual deliginification stage can involve a treatment with an oxidant in either an acidic or an alkaline medium. Suitable oxidants include sodium chlorite, hydrogen peroxide, peroxyacids such as peracetic acid and Caro's acid, ozone, oxygen, chlorine and chlorine dioxide. Exemplary methods of residual delignification include sequential treatment with acidified sodium chlorite followed by alkaline hydrogen peroxide, or sequential treatment with peracetic acid followed by alkaline hydrogen peroxide. The yield of nanocellulose from biomass can be at least 10%, 15%, 20%, 25%, 30%, 35%, 40%, 45% or 50%. Nanocellulose produced according to the foregoing methods is free from sulfate groups and can exhibit a greater degree of stability than conventionally produced nanocellulose. For example, the nanocellulose can have a higher thermal stability than conventional nanocellulose and higher recalcitrance to enzymatic and chemical degradation.

Precipitation of alkali lignin is well-known (see U.S. Pat. No. 8,771,464). Lignin can be obtained from the filtrate by acidifying the solution to a pH of less than 10.0, 9.0, 8.0, 7.0, 6.0, 5.0, 4.0, 3.5, 3.0, 2.5, 2.0, 1.5 or 1.0 using a conventional acid, including organic acids like acetic acid, formic acid, trifluoroacetic acid, and the like, and mineral acids such as hydrochloric acid, hydrobromic acid, hydroioidic acid, phosphoric acid, sulfuric acid, nitric acid, perchloric acid, boric acid and the like. The adjustment of pH causes precipitation of the lignin, which can be collected by filtration, washed, and spray dried to give lignin powder.

### Hydrolysis Pathway

The acidic hydrolysis can be carried out using any strong acid. Exemplary acids include mineral acids such as hydrochloric acid, hydrobromic acid, hydroioidic acid, phosphoric acid, sulfuric acid and the like. The ratio of acid to biomass could be 0.1-100% and the solids content can be 1-75%. The acid can combined with the torrefied biomass at a temperature of at least 23° C., 50° C., 75° C., 100° C., 125° C., 150° C., 175° C., 200° C., 225° C., 250° C., or 275° C. The acid can combined with the torrefied biomass at a temperature between 23-275° C., 50-250° C., 100-250° C., 100-225° C., or 100-200° C. The acid can combined with the torrefied biomass for a period of at least 5 minutes, 10 minutes, 15 minutes, 20 minutes, 25 minutes, 30 minutes, 35 minutes, 40 minutes, 45 minutes, 50 minutes, 55 minutes, 60 minutes, 70 minutes, 80 minutes, 90 minutes, 100 minutes, 110 minutes, or 120 minutes. The resulting suspension is subsequently filtered to separate nanocellulose and lignin fractions. The nanocellulose containing suspension is further centrifuged to separate the mineral acid and the nanocellulose is further washed and recovered. The acid hydrolyzed lignin is subsequently washed to remove the dissolved carbohydrates and recover lignin.

### Nanocellulose Processing

The nanocellulose product from either bulk delignification or acidic hydrolysis can be either cellulose nanocrystals or cellulose nanofibrils. The product characteristics can be tightly controlled by the particle size distribution of the torrefied materials and severity of the torrefaction and the chemical treatment stages employed. Generally speaking, more intensive torrefication, characterized by higher torrefaction temperatures at longer times, and chemical treatment results in nanocrystalline cellulose, whereas less intensive steps results in cellulose nanofibrils.

The nanocellulose can be subjected to a final upgrading and recovery process. In order to produce nanocellulose gel, the nanocellulose is dispersed and homogenized (if needed) in aqueous medium by sonication. The sonication can be conducted for a period of at least 5 minutes, 10 minutes, 15 minutes, 20 minutes, 25 minutes, 30 minutes, 35 minutes, 40 minutes, 45 minutes, 50 minutes, 55 minutes, 60 minutes, 70 minutes, 80 minutes, 90 minutes, 100 minutes, 110 minutes, or 120 minutes. The sonication can be conducted for a period of 5-120 minutes, 10-90 minutes, 10-60 minutes, 15-60 minutes, or 20-60 minutes. The resulting gel can have a solids content of at least 0.5%, 1%, 2%, 3%, 4%, 5%, 6%, 7%, 8%, 9% or 10%. The resulting gel can have a solids content from 0.5-10%, 1-10% or 2-10%.

The resulting nanocellulose can made more transparent by an oxidation step. Transparent gels can then be employed for the production of transparent films. The nanocellulose can also be used to develop stable foam forming micelles, which upon settling are readily separated from the aqueous medium. A foam forming suspension can be prepared by sonicating the nanocellulose at a suitable concentration with a chemical reagent in aqueous medium (FIG. 5). For composite applications, the nanocellulose can be spray dried to obtain the powder form which can be subsequently used in the development of composites. Nanocellulose in the liquid form can also be directly dispersed in the organic resin or used in the in-situ polymerization of monomeric resin components to obtain the desired composites.

### Lignin Processing

The lignin fraction obtained from either bulk delignification or acidic hydrolysis can have a carbon content of at least 65%, 70%, 75%, 80%, 85%, 90%, or 95%. The lignin fraction obtained via delignification or acid hydrolysis route can have a carbon content from 65%-99%, 70-99%, 75-99%, 80-99%, 85-99%, 90-99% or 95-99%.

The lignin can be dried without compromising the surface activity (for example spray drying or flash drying) and can be cured. Curing can be carried out at temperature of at least 300° C., 400° C., 500° C., 600° C., 700° C., 800° C., or 900° C. Curing can be carried out at temperature from 300-900° C., 400-900° C., 500-900° C., 600-900° C., 700-900° C., 800-900° C., 300-400° C., 300-500° C., 300-600° C., 300-700° C., 300-800° C., or 300-900° C. The ramping rates can be from 1-25° C./minute either in an inert environment or sub-stoichiometric supply of oxygen to provide carbon black. Carbon fibers can be prepared from lignin using a solvent/melt spinning step followed by carbonization. The carbonization can be carried out at temperature of at least 300° C., 400° C., 500° C., 600° C., 700° C., 800° C., 900° C., or 1,000° C. Carbonization can be carried out at temperature from 300-1,000° C., 400-1,000° C., 500-1,000° C., 600-100° C., 700-1,000° C., 800-1,000° C., 900-1,000° C., 300-400° C., 300-500° C., 300-600° C., 300-700° C., 300-800° C., or 300-900° C. The ramping rates can be from 1-25° C./minute either in an inert environment or sub-stoichiometric supply of oxygen to provide carbon black. The yield of carbon black from biomass can be from at least 10%, 20%, 25%, 30%, 35%, 40%, 45% or 50%.

The bio-based carbon black can have surface areas of at least 30 m²/g, 130 m²/g, 230 m²/g, 330 m²/g, 430 m²/g, 530 m²/g, 630 m²/g, 730 m²/g, 830 m²/g, 930 m²/g, 1030 m²/g, 1130 m²/g, 1230 m²/g, 1330 m²/g, 1430 m²/g, 1530 m²/g, 1630 m²/g, 1730 m²/g, 1830 m²/g, 1930 m²/g or 2030 m²/g.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

### Torrefaction of Douglas-Fir Wood Chips

Douglas-fir white wood chips were torrefied in a N2 environment at 260° C. for 15 minutes. The resulting torrefied wood chips were cooled by purging cold nitrogen into the torrefaction oven. The yields of torrefied wood chips was 85% dry weight of the starting biomass. The material obtained consisted mostly of depolymerized lignin and cellulose with a minor fraction of hemicellulosic components. Typical cellulose contents of this material is between 51-53% and lignin content is between 43-47%, with the hemicellulosic components between 0-5%. Torrefaction enhanced the crystallinity of cellulosic components by 30-100%, which was characterized by using wide angle X-ray diffraction. The torrefied biomass was dark brown in color and was extremely brittle. Subsequent grinding in an attrition mill using a 200 mesh screen generated particles smaller than 75 μm in size. No mass loss in this size reduction step was observed.

### Example 2

### Preparation of Cellulose Nanofibrils and carbon black from Torrefied Douglas-Fir Wood Chips by Alkaline Delignification Approach

Torrefied Douglas-fir particles from Example 1 was subjected to an alkaline delignification treatment using 5% NaOH solution at 140° C. for 60 minutes at a solids consistency of 20%. The resulting slurry was subsequently filtered using a Buchner funnel and Whatman® filter paper to separate the liquid containing the dissolved lignin and a cellulose-rich water insoluble fraction.

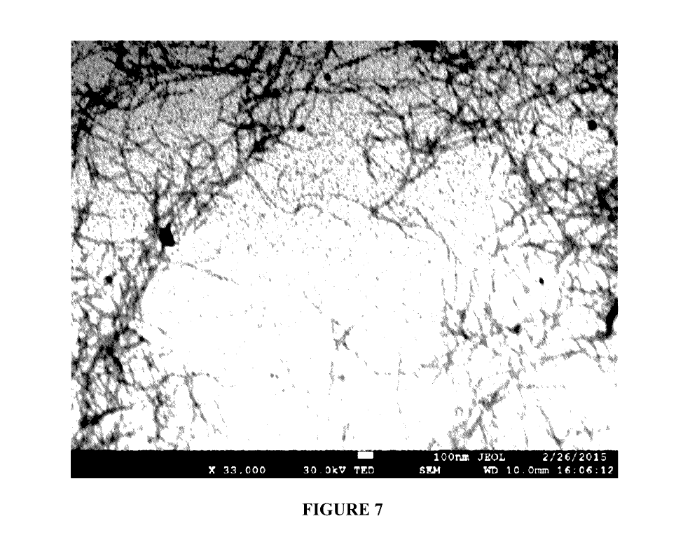

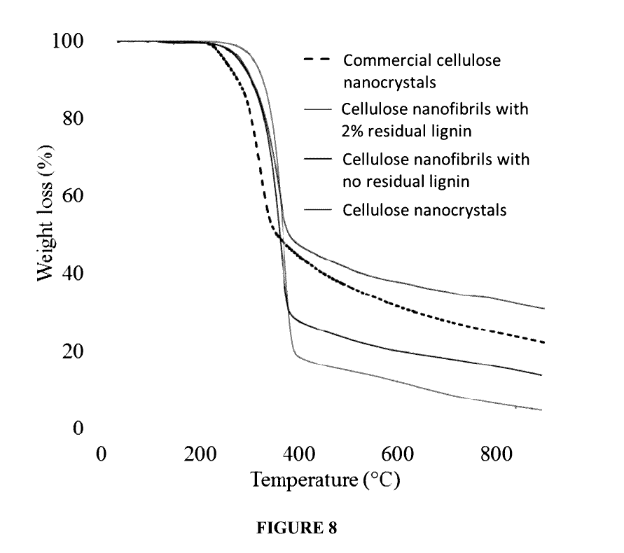

The cellulose-rich water insoluble fraction was subsequently bleached to obtain the nanocellulose fraction. The bleaching sequence involves treatment with acidified sodium chlorite followed by alkaline hydrogen peroxide. This sequence resulted in pure nanocellulose with no detectable lignin in a yield of 31% based on the dry weight of the starting wood chips. Similar nanocellulose was obtained by replacing the bleaching step with peracetic acid followed by alkaline hydrogen peroxide. Use of alkaline hydrogen peroxide alone resulted in 2-5% lignin content in the final nanocellulose fraction with an overall yield of 37% based on the dry weight of the starting wood chips. SEM and TEM examination of the cellulose nanofibrils confirmed the length of cellulose nanofibrils in the range of 300-1000 nm and a diameter of less than 10 nm. The fibrils obtained have a high aspect ratio of 30-100 and are highly entangled (FIG. 7). The samples had a higher thermal stability (260-280° C.) as measured by the onset temperature of the curve (To) compared to the nanocellulose samples produced from the conventional processes (FIG. 8). Further, the steeper slope following the onset temperature of materials derived from the proposed invention indicates a high degree a molecular weight uniformity.

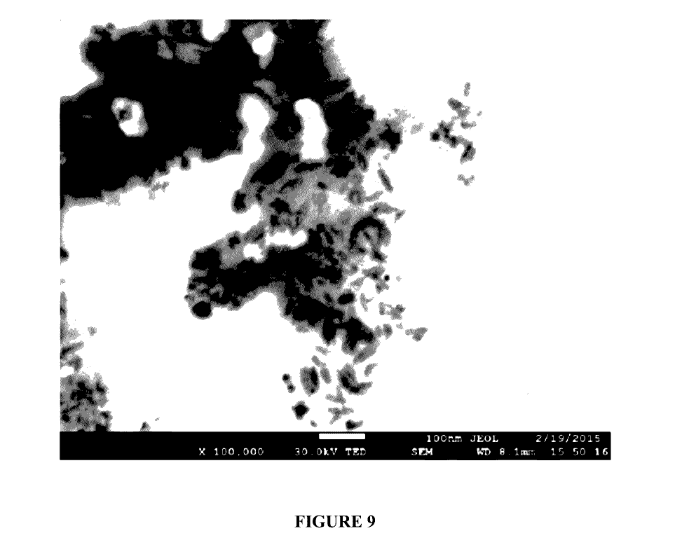

The dissolved lignin was recovered from the water soluble fraction by adjusting the pH of the liquid fraction to 2.0 using dilute sulfuric acid. The resulting precipitated lignin was centrifuged, filtered and subsequently washed. The lignin suspension was then spray dried to obtain the lignin powder that had a carbon content of 65-70%. SEM examination indicated that lignin had a particle size in the range of 10-100 nm (FIG. 9).

### Example 3

### Two Stage Bulk Delignification of Torrefied Douglas-Fir Wood Chips

Torrefied Douglas-fir particles from the Example 1 were subjected to a peracetic acid (PAA) treatment followed by a treatment with 1% sodium hydroxide treatment. This process resulted in greater than 80% delignification. The slurry resulting from the alkaline delignification was subsequently filtered through Whatman® filter paper under vacuum using a Buchner funnel and the resulting cellulose-rich water insoluble fraction was washed and subjected to the residual delignification stages as described in Example 2 to obtain nanocellulose material.

### Example 4

### Preparation of Cellulose Nanocrystals and Carbon Black from Torrefied Douglas-Fir Wood Chips by Alkaline Delignification Approach

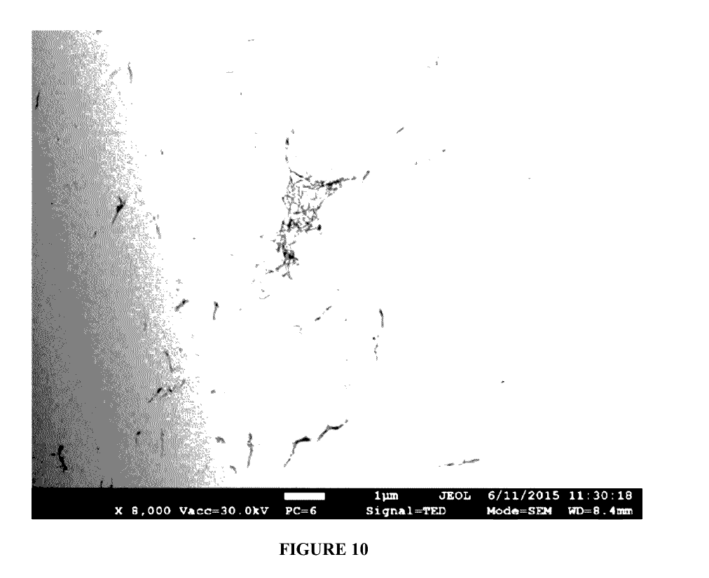

The torrefied wood chips obtained from Example 1 was subjected to an ultra-fine grinding to obtain particles with an average size of 1 μm. The submicron sized torrefied particles are subsequently subjected to the delignification conditions described in Example 2 and centrifuged to separate the dissolved lignin. The resulting water insoluble cellulose-rich fraction is subjected to the residual delignification conditions described in Example 2 to obtain a process stream containing pure cellulose nanocrystals. Cellulose nanocrystals thus obtained has a length of <250 nm and width of <10 nm (FIG. 10).

### Example 5

### Alkali Catalyzed Torrefaction to Obtain Carbon as the Dedicated Product in High Yield

Loblolly pine wood chips was immersed in 1% sodium hydroxide solution at 20% consistency (5% alkali concentration based on the dry weight of the wood chips). The alkaline impregnation was carried out at room temperature overnight. The alkali impregnated wood chips were subsequently filtered to remove excess water and torrefied under N2. The heating rate was 2° C. per minute to 300° C. and the wood chips were held at 300° C. for 15 minutes. The torrefied wood chips were subsequently ground using an attrition mill to obtain submicron sized particles having a surface area of 450 m²/g.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

What is claimed is:

1. A process for transforming biomass, which comprises the steps:
a) torrefication of biomass;
b) chemical treatment of the torrefied biomass to generate nanocellulose and lignaceous carbon; and
c) separating the nanocellulose and lignaceous carbon.

2. The process according to claim 1, wherein the torrefication step is conducted at a temperature from between 100-500° C.

3. The process according to claim 1, wherein the torrefication step is conducted for a period of time from 2 minutes to 2 hours.

4. The process according to claim 1, wherein the torrefication is conducted in the presence of an acidic or alkaline catalyst.

5. The process according to claim 1, wherein the torrefied biomass is subjected to a size reduction prior to the chemical treatment stage.

6. The process according to claim 5, wherein the torrefied biomass has a particle size from 0.5-50 μm.

7. The process according to claim 1, wherein the chemical treatment stage comprises treatment of the torrefied biomass with an aqueous base to give an alkali mixture.

8. The process according to claim 7, wherein the torrefied biomass is treated with at least one oxidant prior to treatment with an aqueous base.

9. The process according to claim 7, wherein the alkali mixture is treated with at least one oxidant to give a mixture of lignaceous carbon and nanocellulose.

10. The process according to claim 9, comprising separating lignaceous carbon from the mixture of lignaceous carbon and nanocellulose by filtration.

11. The process according to claim 10, comprising carbonizing the lignaceous carbon to give carbon black.

12. The process according to claim 10, comprising adjusting the pH of the filtrate below 10 to precipitate nanocellulose.

13. The process according to claim 1, wherein the chemical treatment stage comprises treatment with an acid to give an acidic mixture.

14. The process according to claim 13, comprising separating lignaceous carbon from the acidic mixture by filtration.

15. The process according to claim 14, comprising carbonizing the lignaceous carbon to give carbon black.

16. The process according to claim 14, comprising adjusting the pH of the filtrate below 10 to precipitate nanocellulose.

17. Carbon black produced by the process of claim 1.

18. The carbon black according to claim 17, having a surface area of at least 450 m²/g.

19. Nanocellulose produced by the process of claim 1.

20. The nanocellulose according to claim 19, having a length less than 250 nm and a wedith less than 10 nm.
